(19) United States
(12) Patent Application Publication
(10) Pub. No.: US 2009/0230877 A1
(43) Pub. Date: Sep. 17, 2009

(54) DISCHARGE LAMP LIGHTING APPARATUS

(75) Inventor: Kengo KIMURA, Niiza-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sanken Electric Co., Ltd., Niiza-shi (JP)

(21) Appl. No.: 12/391,594

(22) Filed: Feb. 24, 2009

(30) Foreign Application Priority Data
Mar. 13, 2008 (JP) 2008-064625

(51) Int. Cl. H05B 41/36

(52) U.S. Cl. 315/291

(57) ABSTRACT

A discharge lamp lighting apparatus is mounted on a single circuit board. The apparatus converts a direct current into an alternating current, applies voltages of opposite phases to both ends of a discharge lamp. The apparatus includes two resonant circuits. Each of the resonant circuits includes a transformer having a primary winding and a secondary winding, a resonant reactor, and resonant capacitors. Output terminals of the two resonant circuits are connected to the ends of the discharge lamp, to apply the voltages of opposite phases to the ends of the discharge lamp, respectively. Resonant characteristics of the two resonant circuits are equalized with each other by determining values of the resonant reactors of the two resonant circuits according to values of stray capacitances determined by the lengths of high-voltage output lines extended from the two resonant circuits to the ends of the discharge lamp.

### BACKGROUND OF THE INVENTION

1. Field of the Invention

The present invention relates to a discharge lamp lighting apparatus for lighting a discharge lamp, in particular, a cold cathode fluorescent lamp (CCFL) of, for example, a liquid crystal display.

2. Description of the Related Art

An example of a discharge lamp lighting apparatus that applies voltages of opposite phases to both ends of a straight discharge lamp and thereby lights the discharge lamp is disclosed in Japanese Unexamined Patent Application Publication No. 2006-221985. The apparatus of this related art includes a master lighting unit and a slave lighting unit, wherein the units output voltages of opposite phases to both ends of a straight discharge lamp to turn on the discharge lamp.

FIG. 1 is a schematic view illustrating the discharge lamp lighting apparatus of the above-mentioned related art and FIG. 2 is a circuit diagram illustrating the apparatus of FIG. 1.

In FIG. 1, a power source unit 11a is centrally arranged on a bottom face 1 of a panel. On the left side of the power source unit 11a, the master lighting unit 12a that is an inverter is arranged. On the right side of the power source unit 11a, the slave lighting unit 12b that is an inverter is arranged. The power source unit 11a supplies a source voltage Vcc to the master and slave lighting units 12a and 12b.

The master lighting unit 12a includes a controller (controller IC) 13a (13a-1, 13a-2), a MOS switch 14a consisting of four MOSFETs arranged in a bridge configuration and serving as switching elements, and a resonant circuit 15 containing a transformer Ta. The resonant circuit 15 provides an AC voltage that is applied through a high-voltage output line 22a to a first end of the discharge lamp 3.

The slave lighting unit 12b includes a controller 13b that operates in response to signals from the controller 13a-1 of the master lighting unit 12a, a MOS switch 14b consisting of four MOSFETs arranged in a bridge configuration and serving as switching elements, and a resonant circuit 16 containing a transformer Tb. The resonant circuit 16 provides an AC voltage that is applied through a high-voltage output line 22b to a second end of the discharge lamp 3.

Each of the MOS switches 14a and 14b includes the four MOSFETs arranged in a bridge configuration and serving as switching elements. The four MOSFETs are a p-type FET Qp1 and an n-type FET Qn1 that form a series circuit and a p-type FET Qp2 and an n-type FET Qn2 that form a series circuit.

The controller 13a-1 of the master lighting unit 12a compares a voltage of a secondary winding S of the transformer Ta rectified through a diode and a voltage of a secondary winding S of the transformer Tb rectified through a diode with a reference voltage and provides an error voltage. Further, the controller 13a-1 compares the error voltage with a triangular signal, generates a pulse signal whose pulse width corresponds to the error voltage, and supplies the pulse signal to the controller 13a-2. The pulse signal is also supplied through terminals 17a and 17b and a signal line 18 to the controller 13b.

Based on the pulse signal from the controller 13a-1, each of the controllers 13a-2 and 13b-1 generates first to fourth drive signals and applies them to the p- and n-type FETs Qp1, Qn1, Qp2, and Qn2, respectively, in such a way as to alternately form an ON period in which the FETs Qp1 and Qn2 simultaneously turn on and an ON period in which the FETs Qp2 and Qn1 simultaneously turn on, thereby generating an AC voltage on a primary winding P of the transformer Ta (Tb).

The polarity of the transformer Tb is opposite to the polarity of the transformer Ta, and therefore, an output voltage from the master lighting unit 12a and an output voltage from the slave lighting unit 12b have opposite phases that are applied to the ends of the discharge lamp 3, respectively, to light the discharge lamp 3.

### SUMMARY OF THE INVENTION

The discharge lamp lighting apparatus of the above-mentioned related art mounts the master lighting unit 12a on a first circuit board and the slave lighting unit 12b on a second circuit board and separately arranges the first and second circuit boards in the vicinities of the ends of the discharge lamp 3. Mounting the two lighting units on the separate two circuit boards complicates the structure of the discharge lamp lighting apparatus and increases the cost thereof.

According to the present invention, a discharge lamp lighting apparatus that is capable of applying voltages of opposite phases to both ends of a discharge lamp with a simple configuration and at low cost can be provided.

According to a first aspect of the present invention, provided is a discharge lamp lighting apparatus mounted on a single circuit board, for converting a direct current into an alternating current, applying voltages of opposite phases to both ends of a discharge lamp, and thereby lighting the discharge lamp. The apparatus includes two resonant circuits each including a transformer, a resonant reactor, and a resonant capacitor, output terminals of the two resonant circuits being connected to the ends of the discharge lamp, to apply the voltages of opposite phases to the ends of the discharge lamp, respectively. Resonant characteristics of the two resonant circuits are equalized with each other by providing a difference between values of the resonant reactors of the two resonant circuits according to values of stray capacitances determined by the lengths of high-voltage output lines extended from the two resonant circuits to the ends of the discharge lamp.

A second aspect of the present invention provides a discharge lamp lighting apparatus mounted on a single circuit board, for converting a direct current into an alternating current, applying voltages of opposite phases to both ends of a discharge lamp, and thereby lighting the discharge lamp. The apparatus includes two resonant circuits each including a transformer, a resonant reactor, and a resonant capacitor, output terminals of the two resonant circuits being connected to the ends of the discharge lamp, to apply the voltages of opposite phases to the ends of the discharge lamp, respectively. Resonant characteristics of the two resonant circuits are equalized with each other by providing a difference between values of the resonant capacitors of the two resonant circuits according to values of stray capacitances determined by the lengths of high-voltage output lines extended from the two resonant circuits to the ends of the discharge lamp.

According to a third aspect of the present invention, the resonant capacitor includes a capacitor having a conductor pattern formed on a top face of the circuit board and a conductor pattern formed on a bottom face of the circuit board.

According to a fourth aspect of the present invention, the high-voltage output line having a flexible substrate employing the capacitor.

According to a fifth aspect of the present invention, the resonant characteristic of each of the resonant circuits is a resonant frequency that is determined by the resonant reactor, resonant capacitor, and stray capacitance related to the resonant circuit.

According to a sixth aspect of the present invention, the resonant reactor is a leakage inductance between primary and secondary windings of the transformer.

### BRIEF DESCRIPTION OF THE DRAWINGS

FIG. 1 is a schematic view illustrating a discharge lamp lighting apparatus according to a related art;

FIG. 2 is a circuit diagram illustrating the discharge lamp lighting apparatus of FIG. 1;

FIG. 3 is a schematic view illustrating a discharge lamp lighting apparatus according to Embodiment 1 of the present invention;

FIG. 4 is a circuit diagram illustrating the discharge lamp lighting apparatus of FIG. 3;

FIG. 5A is a view illustrating an example 1 of a high-voltage output line arranged between a resonant circuit and a discharge lamp in a discharge lamp lighting apparatus according to Embodiment 2 of the present invention;

FIG. 5B is a sectional view illustrating a location depicted by a chain line VB in FIG. 5A;

FIG. 6A is a view illustrating an example 2 of the high-voltage output line arranged between the resonant circuit and the discharge lamp in the discharge lamp lighting apparatus according to Embodiment 2; and

FIG. 6B is a sectional view illustrating a location depicted by a chain line VIB in FIG. 6A.

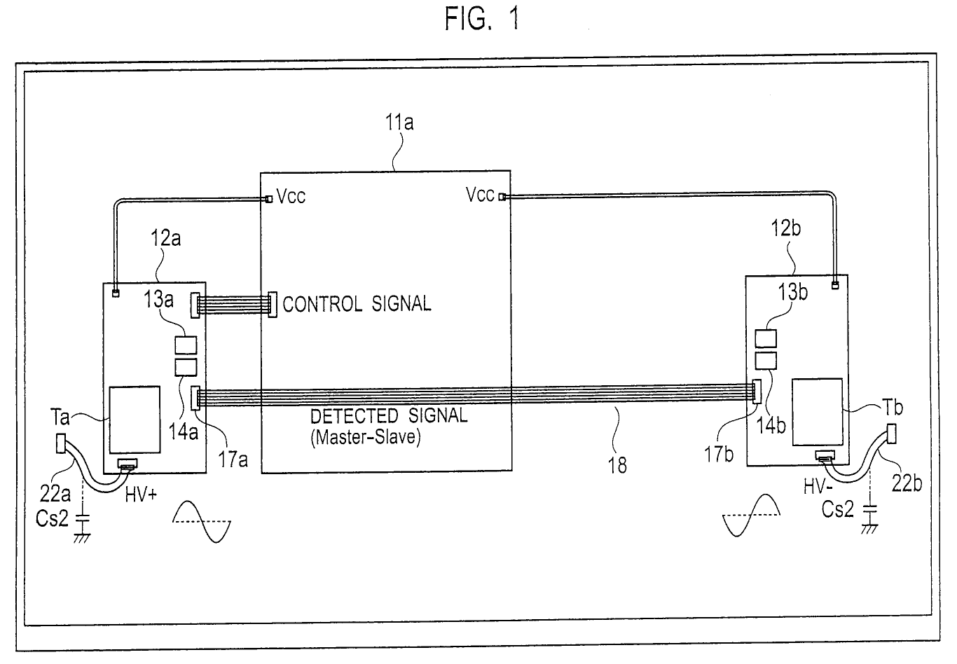

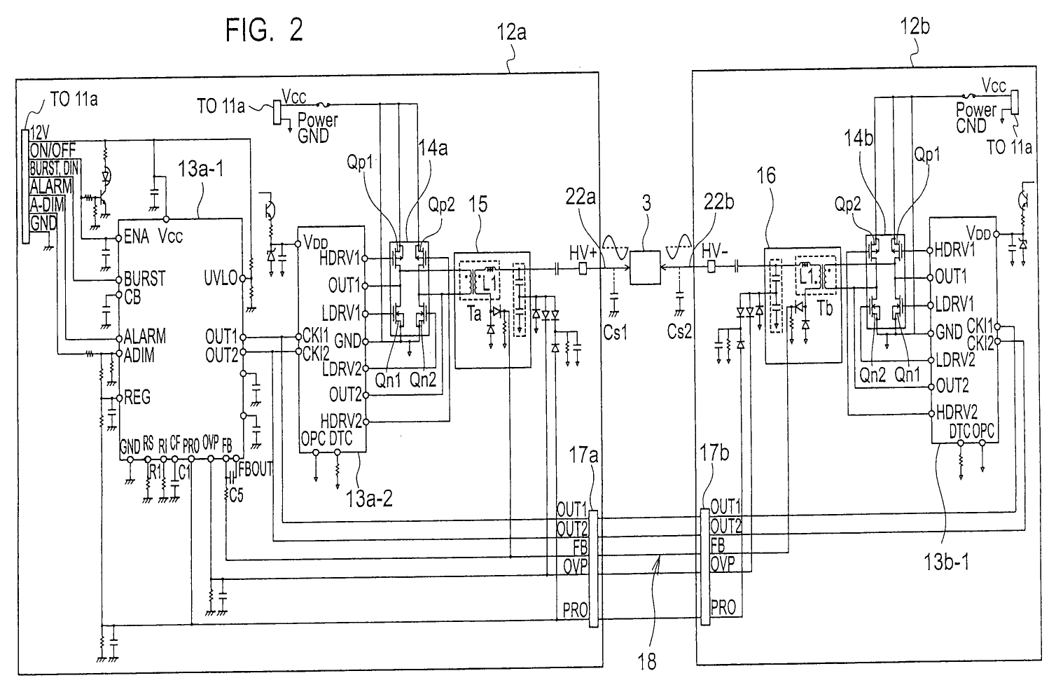

### DESCRIPTION OF THE PREFERRED EMBODIMENT

Discharge lamp lighting apparatuses according to embodiments of the present invention will be explained in detail with reference to the drawings. The discharge lamp lighting apparatus according to each embodiment is arranged on a single circuit board that is arranged on a bottom face of a panel in the vicinity of an end of a discharge lamp. The apparatus is capable of applying voltages of opposite phases to ends of the discharge lamp with a simple configuration and at low cost.

### Embodiment 1

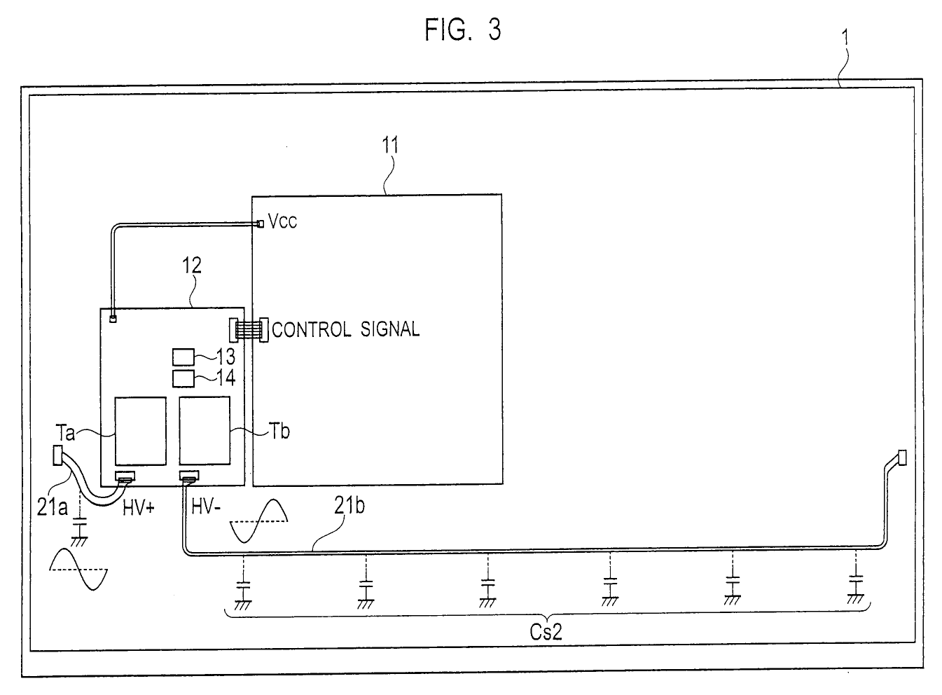

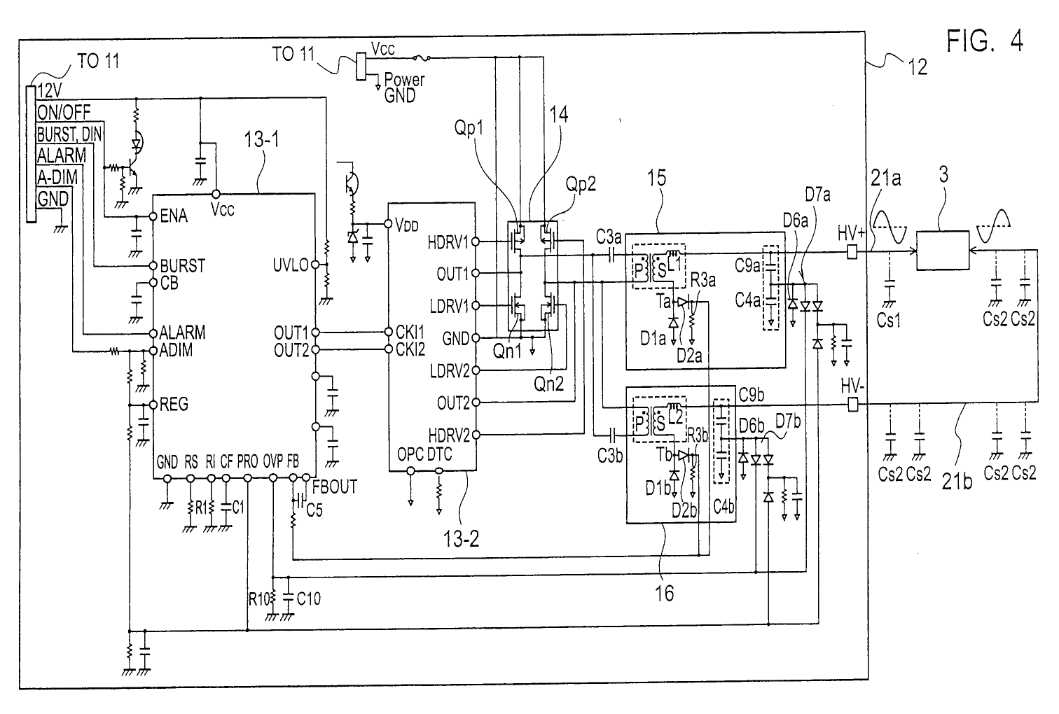

FIG. 3 is a schematic view illustrating a discharge lamp lighting apparatus according to Embodiment 1 of the present invention and FIG. 4 is a circuit diagram illustrating the same.

In FIG. 3, a power source unit 11 is centrally arranged on a bottom face 1 of a panel. On the left side of the power source unit 11, there is arranged a single circuit board 12 on which the discharge lamp lighting apparatus serving as an inverter is mounted. The power source unit 11 supplies a source voltage Vcc to the discharge lamp lighting apparatus on the circuit board 12.

The discharge lamp lighting apparatus includes a controller (controller IC) 13 (13-1, 13-2), a MOS switch 14, a resonant circuit 15 containing a transformer Ta, and a resonant circuit 16 containing a transformer Tb. The resonant circuit 15 outputs an AC voltage to be supplied through a high-voltage output line 21a to a first end of a discharge lamp 3. The resonant circuit 16 outputs an AC voltage to be supplied through a high-voltage output line 21b to a second end of the discharge lamp 3. The discharge lamp 3 is a cold cathode fluorescent lamp (CCFL).

The MOS switch 14 is four MOSFETs arranged in a bridge configuration and serving as switching elements. The four MOSFETs are a high-side p-type FET Qp1 and a low-side n-type FET Qn1 that form a series circuit connected between the source voltage Vcc and the ground and a high-side p-type FET Qp2 and a low-side n-type FET Qn1 that form a series circuit connected between the source voltage Vcc and the ground.

Between a connection point of the p- and n-type FETs Qp1 and Qn1 and a connection point of the p- and n-type FETs Qp2 and Qn2, there is connected a series circuit including a capacitor C3a and a primary winding P of the transformer Ta. The series circuit of the capacitor C3a and the primary winding P of the transformer Ta is connected in parallel with a series circuit including a capacitor C3b and a primary winding P of the transformer Tb. The capacitor C3a is connected to a winding start of the primary winding P of the transformer Ta and the capacitor C3b is connected to a winding end of the primary winding P of the transformer Tb.

Sources of the p-type FETs Qp1 and Qp2 receive the source voltage Vcc. A gate of the p-type FET Qp1 is connected to a terminal HDRV1 of the controller 13-2, a gate of the p-type FET Qp2 is connected to a terminal HDRV2 of the controller 13-2, a gate of the n-type FET Qn1 is connected to a terminal LDRV1 of the controller 13-2, and a gate of the n-type FETQn2 is connected to a terminal LDRV2 of the controller 13-2.

A first end of a secondary winding S of the transformer Ta is connected through the high-voltage output line 21a to a first electrode of the discharge lamp 3. A resonant reactor L1 is a leakage inductance component of the transformer Ta. A second end of the secondary winding S of the transformer Ta is connected to a cathode of a diode D1a and an anode of a diode D2a. The diodes D1a and D2a and a resistor R3a form a lamp current detector to detect a current passing through the secondary winding S and supply a voltage proportional to the detected current to a terminal FB of the controller 13-1.

Between the first end of the discharge lamp 3 and the ground, there is connected a series circuit including capacitors C9a and C4a. A connection point of the capacitors C9a and C4a is connected to a cathode of a diode D6a and an anode of a diode D7a. The diodes D6a and D7a, a resistor R10, and a capacitor C10 form a rectifying-smoothing circuit that detects a voltage proportional to an output voltage and supplies the detected voltage to a terminal OVP of the controller 13-1. The capacitors C9a and C4a form a resonant capacitor.

A first end of a secondary winding S of the transformer Tb is connected through the high-voltage output line 21b to a second electrode of the discharge lamp 3. A resonant reactor L2 is a leakage inductance component of the transformer Tb. A second end of the secondary winding S of the transformer Tb is connected to a cathode of a diode D1b and an anode of a diode D2b. The diodes D1b and D2b and a resistor R3b form a lamp current detector to detect a current passing through the secondary winding S and supply a voltage proportional to the detected current to the terminal FB of the controller 13-1. As mentioned above, the terminal FB is also connected to the output of the lamp current detector having the diodes D1a and D2a and resistor R3a.

Between the second end-of the discharge lamp 3 and the ground, there is connected a series circuit including capacitors C9b and C4b. A connection point of the capacitors C9b and C4b is connected to a cathode of a diode D6b and an anode of a diode D7b. The diodes D6b and D7b, the resistor R10, and the capacitor C10 form a rectifying-smoothing circuit that detects a voltage proportional to an output voltage and supply the detected voltage to the terminal OVP of the controller 13-1. This output is connected to the output of the rectifying-smoothing circuit including the diodes D6a and D7a and these outputs are combined together. The capacitors C9b and C4b form a resonant capacitor.

The controller 13-1 compares the voltage of the secondary winding S of the transformer Ta rectified through the diodes and the voltage of the secondary winding S of the transformer Tb rectified through the diodes witha reference voltage, provides an error voltage according to a result of the comparison, compares the error voltage with a triangular signal, generates a pulse signal whose pulse width corresponds to the error voltage, and outputs the pulse signal to the controller 13-2.

Based on the pulse signal outputted from the controller 13-1, the controller 13-2 generates first to fourth drive signals and applies them to the p- and n-type FETs Qp1, Qn1, Qp2, and Qn2, respectively, in such a way as to alternately form an ON period in which the FETs Qp1 and Qn2 simultaneously turn on and an ON period in which the FETs Qp2 and Qn1 simultaneously turn on, thereby generating AC voltages on the primary windings P of the transformers Ta and Tb.

A connection point of the source of the p-type FET Qp1 and the drain of the n-type FET Qn1 is connected through the capacitor C3a to the winding start of the primary winding P of the transformer Ta and is connected through the capacitor C3b to the winding end of the primary winding P of the transformer Tb, so that the voltages generated by the transformers Ta and Tb have opposite phases. Namely, a voltage from the resonant circuit 15 and a voltage from the resonant circuit 16 have opposite phases and are applied to the ends of the discharge lamp 3, respectively, to light the discharge lamp 3.

According to the present embodiment, the two resonant circuits 15 and 16 should have the same resonant characteristic to apply the voltages of opposite phases to the ends of the discharge lamp 3. That is, values of the resonant reactors L1 and L2 of the resonant circuits 15 and 16 are determined according to values of stray capacitances Cs1 and Cs2 those are dependent on a length of the high-voltage output line 21a extended from the resonant circuit 15 to the first end of the discharge lamp 3 and a length of the high-voltage output line 21b extended from the resonant circuit 16 to the second end of the discharge lamp 3, respectively. These lengths are not the same with each other, and therefore, the values of the resonant reactors L1 and L2 to be determined will have a difference between them.

The stray capacitance Cs1 appears between the high-voltage output line 21a and the ground and the stray capacitance Cs2 appears between the high-voltage output line 21b and the ground.

The resonant characteristic of each resonant circuit is, for example, a resonant frequency. A resonant frequency f1 of the resonant circuit 15 is determined by the resonant reactor L1, resonant capacitors C9a and C4a, and stray capacitance Cs1. A resonant frequency f2 of the resonant circuit 16 is determined by the resonant reactor L2, resonant capacitors C9b and C4b, and stray capacitance Cs2.

More precisely, the resonant frequency f1 of the resonant circuit 15 is determined by

f1=1/{2π√(L1×(Ca+Cs1))} (1).

The resonant frequency f2 of the resonant circuit 16 is determined by

f2=1/{2π√(L2×(Cb+Cs2))} (2),

where

Ca=(C4a×C9a)/(C4a+C9a), and

Cb=(C4b×C9b)/(C4b+C9b).

To equalize the resonant frequencies f1 and f2 with each other on the basis that values of the resonant capacitors Ca and Cb are equal to each other, the resonant reactor L2 should satisfy a relationship of

L2=L1×(Ca+Cs1)/(Ca+Cs2) (3).

If the high-voltage output line 21b is long, the stray capacitance Cs2 is large, and if the same is short, the stray capacitance Cs2 is small. If the line 21b is longer than the line 21a, the value of the resonant reactor L2 of the line 21b is decreased or the value of the resonant reactor L1 of the line 21a is increased, to provide a difference between the values of the resonant reactors L1 and L2 so as to satisfy the expression (3).

Instead of manipulating the resonant reactors L1 and L2, manipulating the resonant capacitors Ca and Cb can also equalize the resonant frequencies f1 and f2 of the resonant circuits 15 and 16. Namely, a difference is created between the values of the resonant capacitors Ca and Cb according to the values of the stray capacitances Cs1 and Cs2, the value of Cs1 being dependent on the length of the high-voltage output line 21a extended from the resonant circuit 15 to the first end of the discharge lamp 3 and the value of Cs2 being dependent on the length of the high-voltage output line 21b extended from the resonant circuit 16 to the second end of the discharge lamp 3.

That is, to equalize the resonant frequencies f1 and f2 with each other on the basis that the values of the resonant reactors L1 and L2 are equal to each other, the resonant capacitor Cb should satisfy a relationship of

Cb=Ca+(Cs1−Cs2) (4).

If the high-voltage output line 21b is long, the stray capacitance Cs2 is large, and if the same is short, the stray capacitance Cs2 is small. If the line 21b is longer than the line 21a, the value of the resonant capacitor Ca is increased or the value of the resonant capacitor Cb is decreased, to provide a difference between the values of the resonant capacitors Ca and Cb so as to satisfy the expression (4).

In this way, the discharge lamp lighting apparatus according to the embodiment arranges the apparatus on the single circuit board 12 and equalizes the resonant characteristics of the two resonant circuits 15 and 16 with each other by compensating a difference between the values of the stray capacitances Cs1 and Cs2 determined by the lengths of the high-voltage output lines 21a and 21b extended from the resonant circuits 15 and 16 to the discharge lamp 3. That is, the embodiment differs the values of the resonant reactors L1 and L2 or the values of the resonant capacitors Ca and Cb of the resonant circuits 15 and 16 from each other. As results, the apparatus of the embodiment is simple and inexpensive to correctly apply voltages of opposite phases to the ends of the discharge lamp 3.

### Embodiment 2

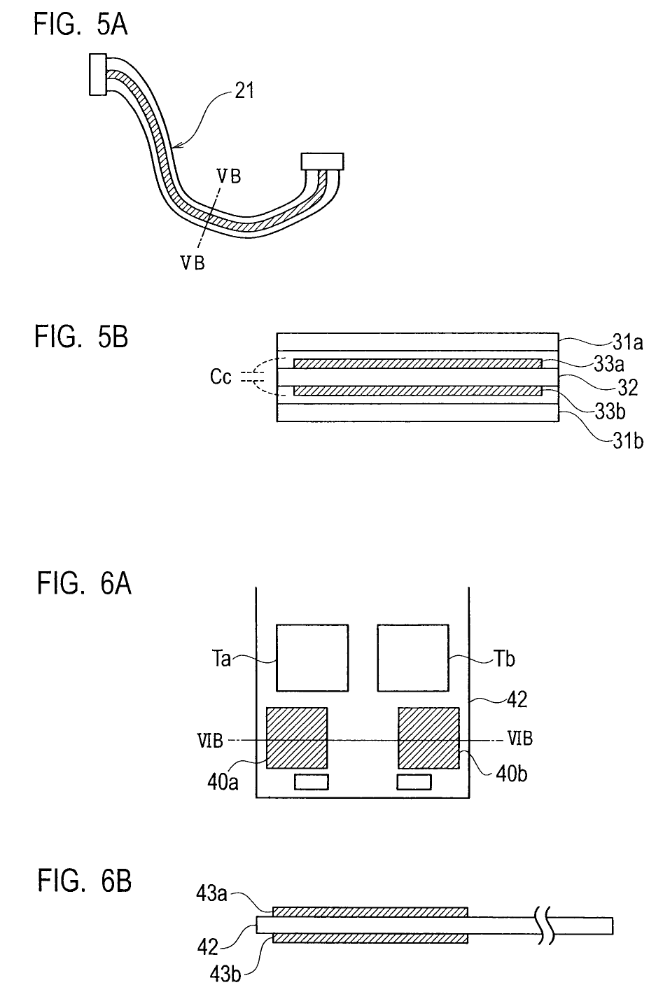

FIGS. 5A and 5B are views illustrating an example 1 of a high-voltage output line arranged from a resonant circuit to a discharge lamp in a discharge lamp lighting apparatus according to Embodiment 2 of the present invention.

In FIG. 5A, the high-voltage output line 21a (21b) includes a flexible printed substrate 21 that is freely bendable. In FIG. 5B, the flexible printed substrate 21 includes a base 32, a conductor pattern 33a formed on a top face of the base 32, a conductor pattern 33b formed on a bottom face of the base 32, and covers 31a and 31b covering the conductor patterns 33a and 33b.

The conductor pattern 33a on the top face of the base 32 and the conductor pattern 33b on the bottom face of the base 32 form a capacitor Cc. The capacitor Cc may serve as the resonant capacitor Ca (Cb) of Embodiment 1.

FIGS. 6A and 6B are views illustrating an example 2 of the high-voltage output line arranged from the resonant circuit to the discharge lamp in the discharge lamp lighting apparatus according to Embodiment 2.

In FIG. 6A, the example 2 arranges transformers Ta and Tb on a circuit board 42. The transformers Ta and Tb are provided with conductor pattern portions 40a and 40b, respectively. As illustrated in an enlarged sectional view of FIG. 6B, the conductor pattern portion 40a has a conductor pattern 43a substantially having a square shape on a top face of the circuit board 42 and a conductor pattern 43b substantially having a square shape on a bottom face of the circuit board 42. An output line (not illustrated) of the transformer Ta (Tb) is connected to one (for example, 43a) of the conductor patterns 43a and 43b.

The conductor pattern 43a on the top face of the circuit board 42 and the conductor pattern 43b on the bottom face of the circuit board 42 form a capacitor. The capacitor may serve as the resonant capacitor Ca (Cb) of Embodiment 1.

The present invention is not limited to the above-mentioned Embodiments 1 and 2. According to Embodiments 1 and 2, the discharge lamp 3 is a cold cathode fluorescent lamp (CCFL). The discharge lamp to which the present invention is applied is not limited to the CCFL. For example, external electrode fluorescent lamps (EEFLs) that are connected in parallel are adoptable for the present invention.

The present invention is also applicable to an equivalent EEFL consisting of a CCFL with capacitors connected to each end of the CCFL in series. If the present invention is applied to discharge lamps that have positive impedance characteristics and are connected in parallel, the discharge lamps will collectively be considered as a single discharge lamp.

In summary, the discharge lamp lighting apparatus provided by the present invention is mounted on a single circuit board, to simplify the structure thereof and reduce the cost thereof. According to the values of stray capacitances that are depending on the lengths of high-voltage output lines from two resonant circuits to a discharge lamp, the apparatus provides a difference between the values of resonant reactors or resonant capacitors of the two resonant circuits and outputs voltages of opposite phases to both ends of the discharge lamp.

This application claims benefit of priority under 35USC §119 to Japanese Patent Application No. 2008-064625, filed on Mar. 13, 2008, the entire content of which is incorporated by reference herein. Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. A discharge lamp lighting apparatus mounted on a single circuit board, for converting a direct current into an alternating current, applying voltages of opposite phases to both ends of a discharge lamp, and thereby lighting the discharge lamp, the apparatus comprising:
two resonant circuits each including a transformer, a resonant reactor, and a resonant capacitor, output terminals of the two resonant circuits being connected to the ends of the discharge lamp and configured to apply the voltages of opposite phases to the ends of the discharge lamp, respectively, wherein
resonant characteristics of the two resonant circuits is equalized with each other by providing a difference between values of the resonant reactors of the two resonant circuits according to values of stray capacitances determined by the lengths of high-voltage output lines extended from the two resonant circuits to the ends of the discharge lamp.

2. A discharge lamp lighting apparatus mounted on a single circuit board, for converting a direct current into an alternating current, applying voltages of opposite phases to both ends of a discharge lamp, and thereby lighting the discharge lamp, the apparatus comprising:
two resonant circuits each including a transformer, a resonant reactor, and a resonant capacitor, output terminals of the two resonant circuits being connected to the ends of the discharge lamp and configured to apply the voltages of opposite phases to the ends of the discharge lamp, respectively, wherein
resonant characteristics of the two resonant circuits is equalized with each other by providing a difference between values of the resonant capacitors of the two resonant circuits according to values of stray capacitances determined by the lengths of high-voltage output lines extended from the two resonant circuits to the ends of the discharge lamp.

3. The discharge lamp lighting apparatus according to claim 2, wherein
the resonant capacitor includes a capacitor having a conductor pattern formed on a top face of the circuit board and a conductor pattern formed on a bottom face of the circuit board.

4. The discharge lamp lighting apparatus of claim 3, wherein
the high-voltage output line has a flexible substrate employing the capacitor of the resonant capacitor.

5. The discharge lamp lighting apparatus of claim 1, wherein
the resonant characteristic of each of the resonant circuits is a resonant frequency that is determined by the resonant reactor, resonant capacitor, and stray capacitance related to the resonant circuit.

6. The discharge lamp lighting apparatus of claim 2, wherein
the resonant characteristic of each of the resonant circuits is a resonant frequency that is determined by the resonant reactor, resonant capacitor, and stray capacitance related to the resonant circuit.

7. The discharge lamp lighting apparatus of claim 1, wherein
the resonant reactor is a leakage inductance between primary and secondary windings of the transformer.

8. The discharge lamp lighting apparatus of claim 2, wherein
the resonant reactor is a leakage inductance between primary and secondary windings of the transformer.
